(19) United States
(12) Patent Application Publication
(10) Pub. No.: US 2010/0328065 A1
(43) Pub. Date: Dec. 30, 2010

(54) WARNING CIRCUIT AND ELECTRONIC DEVICE

(75) Inventor: TAO WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/779,693

(22) Filed: May 13, 2010

(30) Foreign Application Priority Data
Jun. 29, 2009 (CN) 200910303807.1

(51) Int. Cl. G08B 21/00

(52) U.S. Cl. 340/540

(57) ABSTRACT

A warning circuit includes a sampling unit, a reference voltage unit, a switch unit, and a warning unit. The warning circuit is coupled to a power supply. The sampling unit is used for sampling an input voltage from the power supply to generate a sample voltage. The reference voltage unit is used for providing a reference voltage. The switch unit is used for receiving the sample voltage and the reference voltage. The switch unit is turned on when the sample voltage is lower than reference voltage, and is turned off when the sample voltage is higher than the reference voltage. The warning unit is used for receiving the reference voltage when the switch unit is turned on, and generating a warning indication. A related electronic device using the warning circuit is also provided.

### BACKGROUND

1. Technical Field

The disclosed embodiments relate to warning circuits, and more particularly to a warning circuit of an electronic device.

2. Description of Related Art

Commonly, electronic devices use non-rechargeable or rechargeable batteries. When the battery power gets too low, the electronic device may shutdown or perform erratically. In this situation, a user may lose unsaved data or current operating programs may get corrupted.

What is needed, therefore, is a warning circuit and an electronic device to overcome the above described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a block diagram of an electronic device in accordance with an exemplary embodiment.

FIG. 2 is a circuit diagram of the electronic device of FIG. 1 in accordance with the exemplary embodiment.

### DETAILED DESCRIPTION

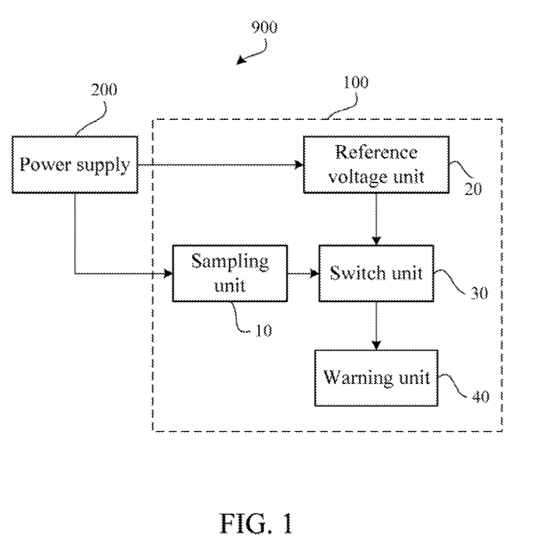

Referring to FIG. 1, an electronic device 900 in accordance with an exemplary embodiment is illustrated. The electronic device 900 includes a warning circuit 100 and a power supply 200. The warning circuit 100 is coupled to the power supply 200, which can be, for example, a rechargeable battery. The warning circuit 100 is used for receiving an input voltage from the power supply 200, and generating a warning indication when the input voltage is too low. The warning circuit 100 includes a sampling unit 10, a reference voltage unit 20, a switch unit 30, and a warning unit 40.

The sampling unit 10 is used for sampling an input voltage from the power supply 200, and generating a sample voltage.

The reference voltage unit 20 is used for receiving the input voltage from the power supply 200, and generating a reference voltage. In other embodiments, the reference voltage unit 20 does not receive the input voltage and directly provides the reference voltage.

The switch unit 30 is used for receiving the sample voltage from the sampling unit 10 and the reference voltage from the reference voltage unit 20. The switch unit 30 turns on when the sample voltage is lower than the reference voltage, and turns off when the sample voltage is higher than the reference voltage.

The warning unit 40 is used for receiving the reference voltage from the reference voltage unit 20 when the switch unit 30 is turned on, and generating a visual and/or audible warning indication, therefore the user can be aware that the input voltage from the power supply 200 is too low.

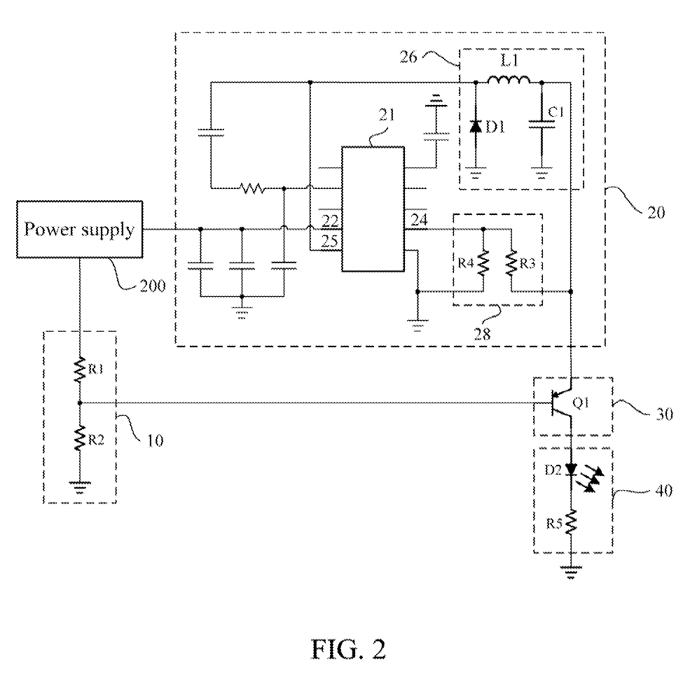

Referring to FIG. 2, the sampling unit 10 includes a first resistor R1 and a second resistor R2. The first resistor R1 is coupled to the power supply 200, one end of the second resistor R2 is coupled to the first resistor R1, and the other end of the second resistor R2 is grounded.

The reference voltage unit 20 includes a controller 21, a generating unit 26, and a feedback unit 28. The controller 21 includes a power terminal 22, a feedback terminal 24, and an output terminal 25. The power terminal 22 is coupled to the power supply 200, the feedback terminal 24 is coupled to the feedback unit 28, and the output terminal 25 is coupled to the generating unit 26. The controller 21 is used for receiving the input voltage from the power supply 200, and generating a pulse voltage. The generating unit 26 receives the pulse voltage and generates the reference voltage. The feedback unit 28 samples the reference voltage to generate a feedback voltage. The controller 21 further receives the feedback voltage, and adjusts a duty cycle of the pulse voltage according to the feedback voltage. In detail, a standard voltage is preset in the controller 21, and the controller 21 compares the feedback voltage with the standard voltage. When the feedback voltage is lower than the standard voltage, the controller 21 increases the duty cycle of the pulse voltage, thus the generating unit 26 increases the reference voltage. Therefore, although the input voltage from the power supply 200 decreases, the reference voltage can be maintained at a predetermined value.

The generating unit 26 includes an inductor L1, a capacitor C1, and a diode D2. One end of the inductor L1 is coupled to the output terminal 25, the other end of the inductor L1 is coupled to the switch unit 30. An anode of the diode D1 is grounded, a cathode of the diode D1 is coupled between the output terminal 25 and the inductor L1. One end of the capacitor C1 is coupled between the inductor L1 and the switch unit 30, the other end of the capacitor C1 is grounded.

The feedback unit 28 includes a third resistor R3 and a fourth resistor R4. One end of the third resistor R3 is coupled between the inductor L1 and the switch unit 30, the other end of the third resistor R3 is coupled to the feedback terminal 24. One end of the fourth resistor R4 is coupled between the third resistor R3 and the feedback terminal 24, the other end of the fourth resistor R4 is grounded.

The switch unit 30 comprises a transistor Q1, a base of the transistor Q1 is coupled between the first resistor R1 and the second resistor R2, an emitter of the transistor Q1 is coupled to the generating unit 26, and a collector of the transistor Q1 is coupled to the warning unit 40.

The warning unit 40 includes a light emitting diode (LED) D2 and a fifth resistor R5. An anode of the LED D2 is coupled to the switch unit 30, a cathode of the LED D2 is grounded through the fifth resistor R5. In other embodiments, a speaker may also be included in the warning unit 40 or may replace the LED D2.

The principal of the warning circuit 100 is as follows: when the electronic device 900 is powered on, the base of the transistor Q1 receives the sample voltage from the sampling unit 10, the emitter of the transistor Q1 receives the reference voltage from the reference voltage unit 26. When the sample voltage is lower than the reference voltage, the transistor Q1 is turned on, and the LED D2 receives the reference voltage and emits light. Therefore, the user can be aware that the input voltage of the power supply is too low.

Alternative embodiments will become apparent to those skilled in the art without departing from the spirit and scope of what is claimed. Accordingly, the present disclosure should be deemed not to be limited to the above detailed description, but rather only by the claims that follow and equivalents thereof.

What is claimed is:

1. A warning circuit coupled to a power supply, the warning circuit comprising:
a sampling unit for sampling an input voltage from the power supply to generate a sample voltage;
a reference voltage unit for providing a reference voltage;
a switch unit for receiving the sample voltage and the reference voltage, being turned on when the sample voltage is lower than reference voltage, and being turned off when the sample voltage is higher than the reference voltage; and
a warning unit for receiving the reference voltage when the switch unit is turned on, and generating a warning indication.

2. The warning circuit of claim 1, wherein the power supply is a rechargeable battery.

3. The warning circuit of claim 1, wherein the sampling unit comprises a first resistor and a second resistor, the first resistor is coupled to the power supply, one end of the second resistor is coupled to the first resistor, the other end of the second resistor is grounded, the switch unit comprises a terminal coupled between the first resistor and the second resistor.

4. The warning circuit of claim 1, wherein the reference voltage unit comprises a controller and a generating unit, the controller comprises a power terminal coupled to the power supply and an output terminal coupled to the generating unit, the controller is used for receiving the input voltage and generating a pulse voltage, the generating unit is used for receiving the pulse voltage and generating the reference voltage.

5. The warning circuit of claim 4, wherein the generating unit comprises an inductor, a diode, and a capacitor, one end of the inductor is coupled to the output terminal, the other end of the inductor is coupled to the switch unit, an anode of the diode is grounded, a cathode of the diode is coupled between the output terminal and the inductor, one end of the capacitor is coupled between the inductor and the switch unit, the other end of the capacitor is grounded.

6. The warning circuit of claim 4, wherein the reference voltage unit further comprises a feedback unit, the generating unit further comprises a feedback terminal coupled to the feedback unit, the feedback unit is used for sampling the reference voltage to generate a feedback voltage, the controller adjusts a duty cycle of the pulse voltage according to the feedback voltage.

7. The warning circuit of claim 6, wherein the controller presets a standard voltage, the controller compares the feedback voltage with the standard voltage, when the feedback voltage is lower than the standard voltage, the controller increases the duty cycle of the pulse voltage, and the generating unit increases the reference voltage.

8. The warning circuit of claim 1, wherein the switch unit comprises a transistor, a base of the transistor is coupled to the sampling unit, an emitter of the transistor is coupled to the reference voltage unit, a collector of the transistor is coupled to the warning unit.

9. The warning circuit of claim 1, wherein the warning unit comprises a light emitting diode (LED), an anode of the LED is coupled to the switch unit, a cathode of the LED is grounded.

10. The warning circuit of claim 1, wherein the warning unit comprises a speaker, one end of the speaker is coupled to the switch unit, the other end of the speaker is grounded.

11. An electronic device comprising a warning circuit and a power supply, the warning circuit being coupled to the power supply, the warning circuit comprising:
a sampling unit for sampling an input voltage from the power supply to generate a sample voltage;
a reference voltage unit for providing a reference voltage;
a switch unit for receiving the sample voltage and the reference voltage, being turned on when the sample voltage is lower than reference voltage, and being turned off when the sample voltage is higher than the reference voltage; and
a warning unit for receiving the reference voltage when the switch unit is turned on, and generating a warning indication.

12. The electronic device of claim 11, wherein the power supply is a rechargeable battery.

13. The electronic device of claim 11, wherein the sampling unit comprises a first resistor and a second resistor, the first resistor is coupled to the power supply, one end of the second resistor is coupled to the first resistor, the other end of the second resistor is grounded, the switch unit comprises a terminal coupled between the first resistor and the second resistor.

14. The electronic device of claim 11, wherein the reference voltage unit comprises a controller and a generating unit, the controller comprises a power terminal coupled to the power supply and an output terminal coupled to the generating unit, the controller is used for receiving the input voltage and generating a pulse voltage, the generating unit is used for receiving the pulse voltage and generating the reference voltage.

15. The electronic device of claim 14, wherein the generating unit comprises an inductor, a diode, and a capacitor, one end of the inductor is coupled to the output terminal, the other end of the inductor is coupled to the switch unit, an anode of the diode is grounded, a cathode of the diode is coupled between the output terminal and the inductor, one end of the capacitor is coupled between the inductor and the switch unit, the other end of the capacitor is grounded.

16. The electronic device of claim 14, wherein the reference voltage unit further comprises a feedback unit, the generating unit further comprises a feedback terminal coupled to the feedback unit, the feedback unit is used for sampling the reference voltage to generate a feedback voltage, the controller adjusts a duty cycle of the pulse voltage according to the feedback voltage.

17. The electronic device of claim 16, wherein the controller presets a standard voltage, the controller compares the feedback voltage with the standard voltage, when the feedback voltage is lower than the standard voltage, the controller increases the duty cycle of the pulse voltage, and the generating unit increases the reference voltage.

18. The electronic device of claim 11, wherein the switch unit comprises a transistor, a base of the transistor is coupled to the sampling unit, an emitter of the transistor is coupled to the reference voltage unit, a collector of the transistor is coupled to the warning unit.

19. The electronic device of claim 11, wherein the warning unit comprises a light emitting diode (LED), an anode of the LED is coupled to the switch unit, a cathode of the LED is grounded.

20. The electronic device of claim 11, wherein the warning unit comprises a speaker, one end of the speaker is coupled to the switch unit, the other end of the speaker is grounded.
